(19) United States
(12) Patent Application Publication
(10) Pub. No.: US 2026/0253791 A1
(43) Pub. Date: Aug. 27, 2026

(54) COIL COMPONENT

(71) Applicant: TDK Corporation, Tokyo (JP)

(72) Inventors: Hokuto EDA, Tokyo (JP); Kohei TAKAHASHI, Tokyo (JP); Takahiro NEMOTO, Tokyo (JP); Yuma USAMI, Tokyo (JP); Ryota ISHIKAWA, Tokyo (JP)

(73) Assignee: TDK Corporation, Tokyo (JP)

(21) Appl. No.: 19/535,195

(22) Filed: Feb. 10, 2026

(30) Foreign Application Priority Data
Feb. 21, 2025 (JP) 2025-026573

(51) Int. Cl. H01F 27/29; H01F 17/00

(52) U.S. Cl. CPC H01F 27/292; H01F 17/0013

(57) ABSTRACT

An element body of a coil component is composed of a magnetic powder-containing resin including magnetic powder, and an end portion of a terminal electrode extending parallel to a mounting surface protrudes from an edge on an end surface side. Therefore, the end surface of the element body is less likely to receive mechanical stress, for example, during a wet etching process or a barrel polishing process. In particular, in a region near the mounting surface where the terminal electrode protrudes, the end surface of the element body is less likely to receive stress. Thereby, the magnetic powder of the magnetic powder-containing resin is less likely to be fallen off on the end surface, a decrease in the magnetic properties of the element body is suppressed, and an improvement in coil characteristics such as an inductance value is realized in the coil component.

### CROSS-REFERENCE TO RELATED APPLICATIONS

This application is based upon and claims the benefit of priority from Japanese Patent Application No. 2025-26573, filed on 21 Feb. 2025, the entire contents of which are incorporated herein by reference.

### TECHNICAL FIELD

The present disclosure relates to a coil component.

### BACKGROUND

U.S. Patent Application Publication No. 2020/0168387 discloses a coil component in which a coil is disposed in an element body including magnetic powder. In the coil component of this document, both end portions of the coil are extracted to a mounting surface of the element body by extraction conductors and are respectively connected to a pair of terminal electrodes provided on the mounting surface.

### SUMMARY OF THE INVENTION

The coil component according to the related art described above is manufactured through various processes such as polishing and plating, for example, but it is conceivable that magnetic powder exposed on a surface of the element body may be fallen off by mechanical stress during the processing, and as a result, it is conceivable that the magnetic properties of the element body deteriorate, and coil characteristics such as an inductance value deteriorate.

According to various aspects of the present disclosure, a coil component with improved characteristics is provided.

A coil component according to one aspect of the present disclosure includes: an element body that has a first surface and a pair of end surfaces that face each other in a direction parallel to the first surface and are connected to the first surface, and is composed of a magnetic material including magnetic powder; a coil that is disposed in the element body and has both end portions extracted to the first surface; and a pair of terminal electrodes that are provided on the first surface and are electrically connected to the respective both end portions of the coil, wherein the terminal electrodes extend parallel to the first surface and protrude from an edge on an end surface side on the first surface.

In the end surface of the element body of the coil component, since the terminal electrodes extending parallel to the first surface of the element body protrude from the edge on the end surface side, the end surface of the element body is less likely to receive stress, and the magnetic powder is less likely to be fallen off on the end surface. Therefore, a decrease in the magnetic properties of the element body is suppressed, and a coil component having high coil characteristics is obtained.

### BRIEF DESCRIPTION OF THE DRAWINGS

FIG. 1 is a perspective view illustrating a coil component according to an embodiment.

FIG. 2 is a cross-sectional view illustrating the coil component of FIG. 1.

FIG. 3 is an enlarged view of a main part of the coil component of FIG. 2.

FIG. 4 is an enlarged view of a main part of the coil component of FIG. 2.

FIG. 5 is a cross-sectional view illustrating a coil component with a different configuration.

### DETAILED DESCRIPTION

Hereinafter, embodiments of the present disclosure will be described in detail with reference to the accompanying drawings. In the description of the drawings, the same or corresponding elements are denoted by the same reference numerals, and redundant description is omitted.

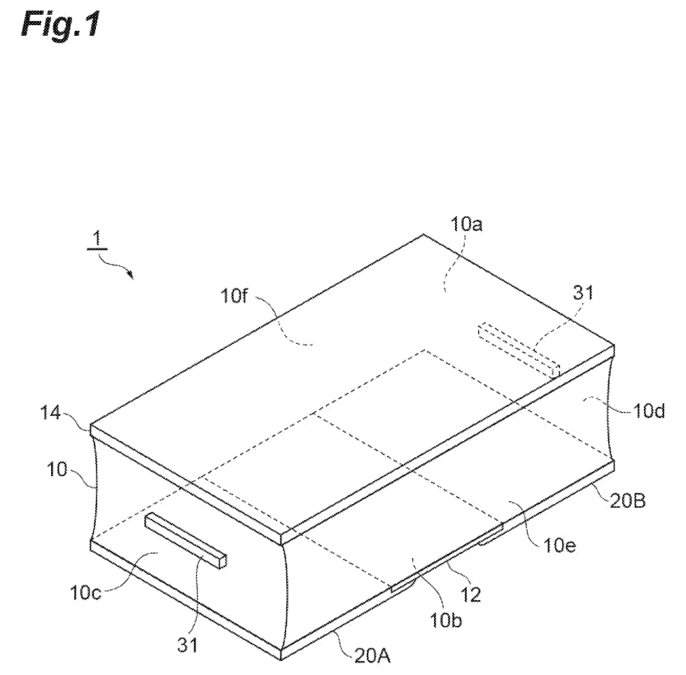

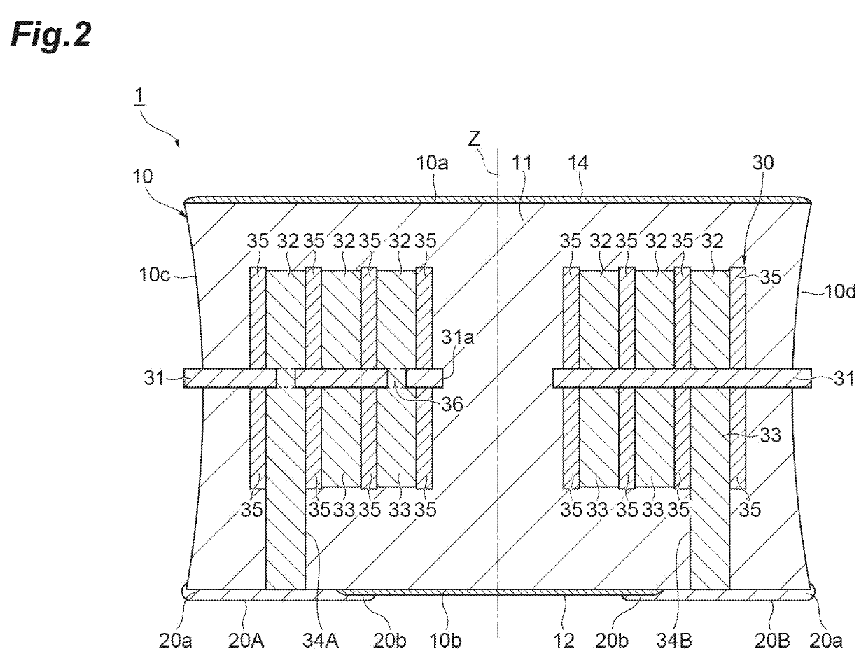

A coil component according to the present embodiment will be described with reference to FIG. 1. As illustrated in FIGS. 1 and 2, a coil component 1 according to an embodiment is configured to include an element body 10, a pair of terminal electrodes 20A and 20B, and a coil 30.

The element body 10 has a rectangular parallelepiped outer shape, and has a pair of main surfaces 10a and 10b parallel to each other, and four side surfaces 10c, 10d, 10e, and 10f connecting the pair of main surfaces 10a and 10b. The rectangular parallelepiped shape in this specification includes a shape of a rectangular parallelepiped in which corner portions and ridge line portions are chamfered, and a shape of a rectangular parallelepiped in which corner portions and ridge line portions are rounded. One main surface 10b (first surface) of the pair of main surfaces 10a and 10b is a surface facing a mounting substrate on which the coil component 1 is mounted, and is also referred to as a mounting surface in the following description. Each of the main surfaces 10a and 10b has a rectangular shape having a long side and a short side, and in the following description, the side surfaces 10c and 10d connecting the short sides of the main surfaces 10a and 10b are also referred to as end surfaces.

The element body 10 is composed of a magnetic powder-containing resin 11, which is a type of magnetic material. The magnetic powder-containing resin 11 is a binder powder in which magnetic powder, which will be described later, is bound by a binder resin. The binder resin is, for example, a thermosetting epoxy resin. In the present embodiment, the content of the magnetic powder in the binder powder is 75 to 92 vol% in volume percent, and 95 to 99 wt% in mass percent. From the viewpoint of magnetic properties, the content of the magnetic powder in the binder powder may be 80 to 92 vol% in volume percent, and 97 to 99 wt% in mass percent.

Both of the pair of terminal electrodes 20A and 20B are provided on the mounting surface 10b of the element body 10. The terminal electrode 20A is located on one short side of the mounting surface 10b and has a rectangular shape extending along the short side over the entire length of the short side. The terminal electrode 20B is located on the other short side of the mounting surface 10b and has a rectangular shape extending along the short side over the entire length of the short side.

On the mounting surface 10b of the element body 10, a space between the pair of terminal electrodes 20A and 20B is covered by a covering material 12. That is, a region of the mounting surface 10b covered by the covering material 12 is not exposed to the outside. The covering material 12 is composed of an insulating material such as an epoxy-based resin or an acrylic-based resin, and a short circuit between the pair of terminal electrodes 20A and 20B is prevented by the covering material 12.

The main surface 10a of the element body 10 is entirely covered by a covering material 14. That is, the entire region of the main surface 10a covered by the covering material 14 is not exposed to the outside. The covering material 14 is composed of an insulating material such as an epoxy-based resin or an acrylic-based resin. A constituent material of the covering material 14 that covers the main surface 10a may be the same as or different from a constituent material of the covering material 12 that covers the mounting surface 10b.

The coil 30 is disposed within the element body 10, as illustrated in FIG. 2. The coil 30 according to the present embodiment is wound around a coil axis Z extending in a direction orthogonal to the mounting surface 10b. The coil 30 is configured to include an insulating substrate 31, planar coils 32 and 33 provided on both surfaces of the insulating substrate 31, and a pair of extraction conductors 34A and 34B.

The insulating substrate 31 extends parallel to the mounting surface 10b, and can be disposed, for example, at an intermediate position between the mounting surface 10b and the main surface 10a. The insulating substrate 31 has a through-hole 31a at a position through which the coil axis Z passes. The insulating substrate 31 reaches the end surfaces 10c and 10d and is exposed from the end surfaces 10c and 10d. The insulating substrate 31 may reach the four side surfaces 10c, 10d, 10e, and 10f and be exposed from the four side surfaces 10c, 10d, 10e, and 10f, or may be exposed only from the end surfaces 10c and 10d. For the insulating substrate 31, a substrate in which a glass cloth is impregnated with a cyanate resin (BT (bismaleimide-triazine) resin: registered trademark) can be used. In addition to BT resin, polyimide, aramid, epoxy, or the like can also be used. As a material for the insulating substrate 31, ceramic or glass can also be used. As the material for the insulating substrate 31, a mass-produced printed circuit board material can be used, and a resin material used for a BT printed circuit board, an FR4 printed circuit board, or an FR5 printed circuit board can be used.

The planar coil 32 is wound for a plurality of turns around the coil axis Z on a surface of the insulating substrate 31 on the main surface 10a side. An inner turn and an outer turn of the planar coil 32 are separated by a resin wall 35 provided on the insulating substrate 31. The planar coil 33 is wound around the coil axis Z on a surface of the insulating substrate 31 on the mounting surface 10b side. An inner turn and an outer turn of the planar coil 33 are also separated by a resin wall 35 provided on the insulating substrate 31, similarly to the planar coil 32.

The planar coil 32 and the planar coil 33 are connected to each other at their inner peripheral ends via a via conductor 36 provided at an edge of the through-hole 31a of the insulating substrate 31. An outer peripheral end of the planar coil 32 overlaps with the terminal electrode 20A when viewed from the main surface 10a side of the element body 10, and is connected to the terminal electrode 20A via the extraction conductor 34A extending inside the element body 10 in a direction orthogonal to the mounting surface 10b. An outer peripheral end of the planar coil 33 overlaps with the terminal electrode 20B when viewed from the main surface 10a side of the element body 10, and is connected to the terminal electrode 20B via the extraction conductor 34B extending inside the element body 10 in a direction orthogonal to the mounting surface 10b. The planar coil 32 and the planar coil 33 are wound such that current flows in the same direction (that is, the same winding direction when viewed from the main surface 10a side of the element body 10) when a voltage is applied between the pair of terminal electrodes 20A and 20B. Since current flows in the same direction in the planar coil 32 and the planar coil 33, generated magnetic fluxes are superimposed and reinforce each other.

Next, the magnetic powder-containing resin 11 constituting the element body 10 will be further described.

The magnetic powder-containing resin 11 covers the coil 30 from the main surface 10a side, and the main surface 10a is constituted by the magnetic powder-containing resin 11 of a portion covering the coil 30 from the main surface 10a side. Similarly, the magnetic powder-containing resin 11 covers the coil 30 from the mounting surface 10b side, and the mounting surface 10b is constituted by the magnetic powder-containing resin 11 of a portion covering the coil 30 from the mounting surface 10b side. The magnetic powder-containing resin 11 constitutes the end surfaces 10c and 10d on the main surface 10a side with respect to the insulating substrate 31, and covers the planar coil 32 from the outside in the same layer. The magnetic powder-containing resin 11 constitutes the end surfaces 10c and 10d on the mounting surface 10b side with respect to the insulating substrate 31, and covers the planar coil 33 from the outside in the same layer. The magnetic powder-containing resin 11 fills an inside of the coil 30 (specifically, an inside of the planar coils 32 and 33 and the through-hole 31a of the insulating substrate 31).

The main surface 10a of the element body 10 is covered with the covering material 14, and the magnetic powder-containing resin 11 is not exposed from the main surface 10a. The mounting surface 10b of the element body 10 is covered with the terminal electrodes 20A and 20B and the covering material 12, and the magnetic powder-containing resin 11 is not exposed from the mounting surface 10b. The side surfaces 10c, 10d, 10e, and 10f of the element body 10 are not covered with the covering materials 12 and 14 and the terminal electrodes 20A and 20B, and the magnetic powder-containing resin 11 is exposed from the side surfaces 10c, 10d, 10e, and 10f.

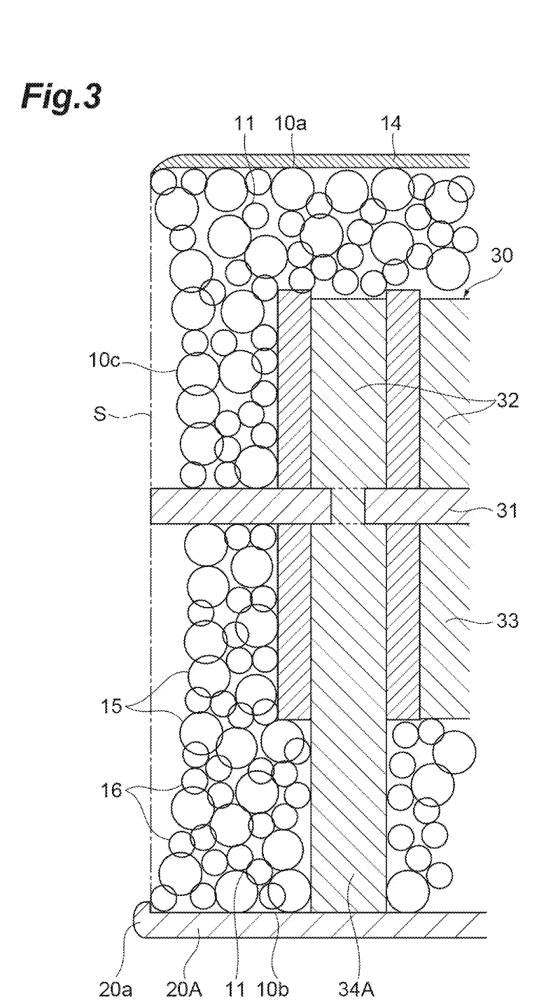

The magnetic powder of the magnetic powder-containing resin 11 is a mixed powder having a plurality of types of average particle diameters. In the present embodiment, the magnetic powder of the magnetic powder-containing resin 11 constituting the element body 10 is a mixed powder of two types, a first magnetic powder 15 and a second magnetic powder 16, as illustrated in FIG. 3. The magnetic powder of the magnetic powder-containing resin 11 may be included in a range of 50 to 90 parts by weight for the first magnetic powder 15 and in a range of 10 to 50 parts by weight for the second magnetic powder, with respect to 100 parts by weight of the mixed powder.

The first magnetic powder 15 can be composed of, for example, an iron-cobalt alloy (FeCo), an iron-silicon alloy (FeSi), an iron-silicon-chromium alloy (FeSiCr), a nanocrystalline alloy, or the like. The average particle diameter of the first magnetic powder 15 is 5 to 40 μm (25 μm as an example).

The second magnetic powder 16 is composed of, for example, an iron-silicon alloy (FeSi), an iron-silicon-chromium alloy (FeSiCr), a Sendust alloy (FeSiAl), Permalloy (FeNi), pure iron (Fe), carbonyl iron, or an amorphous alloy, nanocrystals, or the like. The average particle diameter of the second magnetic powder 16 is 0.1 to 5 μm (2 μm as an example). That is, in the present embodiment, the average particle diameter of the first magnetic powder 15 is larger than the average particle diameter of the second magnetic powder 16.

In the present embodiment, the first magnetic powder 15 and the second magnetic powder 16 of the magnetic powder-containing resin 11 are exposed on the end surface 10c. Also, the magnetic powder-containing resin 11 constituting the end surface 10c is entirely recessed. The element body 10 is obtained, for example, by being diced by a dicer, and the end surface 10c is obtained by a cut surface S formed at that time. This cut surface S substantially coincides with an end surface position of an end portion of the insulating substrate 31 exposed from the end surface 10c. When the cut surface S is subjected to a wet etching process (more specifically, barrel etching) or a barrel polishing process, a part of the magnetic powder exposed on the cut surface S is fallen off or detached. When a part of the second magnetic powder 16 constituting the end surface 10c of the element body 10 is fallen off, the fallen portion becomes a recess, and unevenness can be generated on the end surface 10c. A convex portion of the end surface 10c having the unevenness is composed of the first magnetic powder 15, and on the end surface 10c, the first magnetic powder 15 protrudes to the outside more than the second magnetic powder 16. The second magnetic powder 16 is more likely to be fallen off than the first magnetic powder 15, and the first magnetic powder 15 is more likely to protrude to the outside than the second magnetic powder 16. Regarding the exposure of the magnetic powder of the magnetic powder-containing resin 11, the other surfaces 10d, 10e, and 10f are also the same as the end surface 10c.

As a result, the magnetic powder-containing resin 11 constituting the end surface 10c recedes inward with respect to the cut surface S, and the end surface 10c is entirely recessed. On the other hand, the end portion of the insulating substrate 31 does not recede inward from the position of the cut surface S, and protrudes with respect to the magnetic powder-containing resin 11 on the end surface 10c. The end surface 10d is also the same as the end surface 10c, the magnetic powder-containing resin 11 constituting the end surface 10d recedes inward with respect to the cut surface S, the end surface 10d is entirely recessed, and the end portion of the insulating substrate 31 protrudes with respect to the magnetic powder-containing resin 11 on the end surface 10d.

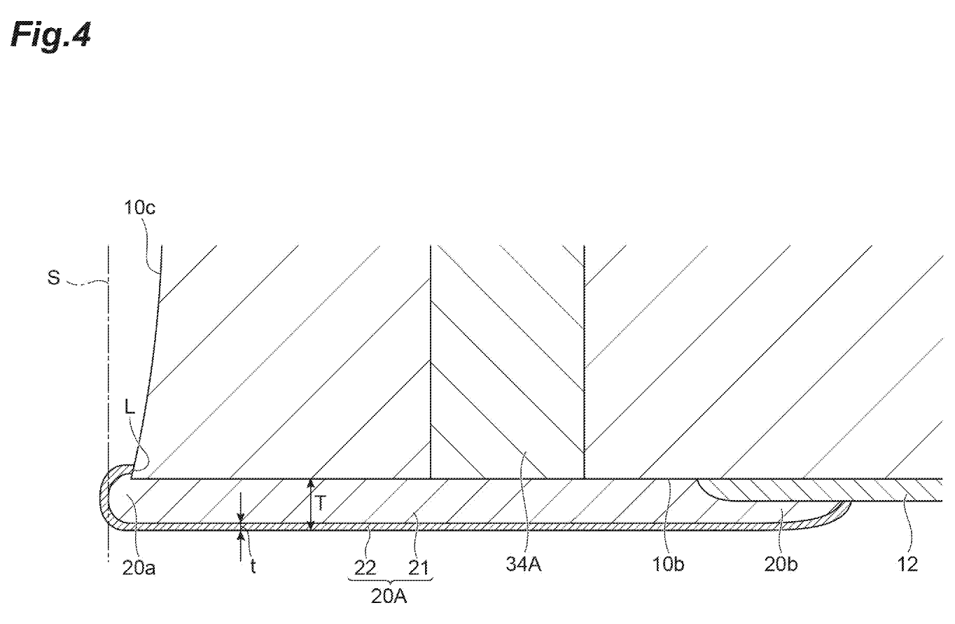

As illustrated in FIG. 4, the terminal electrode 20A extends parallel to the mounting surface 10b, and an end portion 20a protrudes from an edge on the end surface 10c side on the mounting surface 10b. The terminal electrode 20A is configured to include an electrode body 21 and a conductive layer 22 that entirely covers a surface of the electrode body 21. The electrode body 21 is composed of a metal material (for example, Ag) and is formed by a printing method. The conductive layer 22 is a plating layer (for example, a Ni plating layer, a Sn plating layer) formed by electrolytic plating, and constitutes a surface of the terminal electrode 20A. The conductive layer 22 may be composed of a single layer or a plurality of layers. The conductive layer 22 according to the present embodiment is composed of two layers, a Ni plating layer and a Sn plating layer, arranged in order from the side closer to the electrode body 21.

In the aspect illustrated in FIG. 4, both the electrode body 21 and the conductive layer 22 at the end portion 20a of the terminal electrode 20A protrude from the edge on the end surface 10c side on the mounting surface 10b. At this time, a position of an end portion of the electrode body 21 protruding from the edge on the end surface 10c side on the mounting surface 10b may coincide with the cut surface S. An aspect may be adopted in which the electrode body 21 of the terminal electrode 20A does not protrude from the edge on the end surface 10c side on the mounting surface 10b, and only the conductive layer 22 protrudes from the edge on the end surface 10c side on the mounting surface 10b.

As illustrated in FIG. 4, the end portion 20a of the terminal electrode 20A may protrude from the cut surface S. In this case, the end portion 20a of the terminal electrode 20A protrudes from an end portion of the insulating substrate 31. A protrusion length of the end portion 20a of the terminal electrode 20A (that is, a protrusion length from the edge of the mounting surface 10b) may be longer than, shorter than, or approximately the same as a protrusion length of the end portion of the insulating substrate 31 (that is, a protrusion length from a substrate peripheral region on the end surface 10c).

In the present embodiment, a part of the end portion 20a of the terminal electrode 20A wraps around from the mounting surface 10b side to the end surface 10c side. More specifically, both the electrode body 21 and the conductive layer 22 at the end portion 20a of the terminal electrode 20A wrap around to the end surface 10c side. The electrode body 21 is provided, for example, along the short side on the end surface 10c side on the mounting surface 10b, but it is considered that a part of the electrode body 21 wraps around to the end surface 10c side by being plastically deformed by mechanical stress during the above-described wet etching process or barrel polishing process. For example, a wrap-around length L of the end portion 20a of the terminal electrode 20A along the end surface 10c may be longer than a thickness t of the conductive layer 22 and shorter than a thickness T of a portion of the terminal electrode 20A other than the end portion (t < L < T). The wrap-around length L of the end portion 20a of the terminal electrode 20A is, for example, 10 to 20 μm (15 μm as an example), the thickness t of the conductive layer 22 is, for example, 2 to 9 μm (6 μm as an example), and the thickness T of the terminal electrode 20A is, for example, 21 to 40 μm (40 μm as an example). An aspect may be adopted in which only the conductive layer 22 at the end portion 20a of the terminal electrode 20A wraps around to the end surface 10c side. An aspect may also be adopted in which the end portion 20a of the terminal electrode 20A does not wrap around to the end surface 10c side at all, and the end surface 10c is completely exposed from the terminal electrode 20A.

An end portion 20b opposite to the end portion 20a protruding from the edge on the end surface 10c side on the mounting surface 10b is in contact with the covering material 12. Specifically, the end portion 20b of the terminal electrode 20A covers an upper side of the covering material 12. That is, the covering material 12 enters under the end portion 20b of the terminal electrode 20A. A portion covering the upper side of the covering material 12 is significantly thinner than a portion not covering the upper side of the covering material 12. In the present embodiment, the end portion 20bof the terminal electrode 20A becomes gradually thinner toward a tip.

The terminal electrode 20B extends parallel to the mounting surface 10b similarly to the terminal electrode 20A, and an end portion 20a protrudes from an edge on the end surface 10d side on the mounting surface 10b. Since an aspect in which the end portion 20a of the terminal electrode 20B protrudes from the edge on the end surface 10d side on the mounting surface 10b is the same as or similar to an aspect in which the end portion 20a of the terminal electrode 20A protrudes from the edge on the end surface 10c side on the mounting surface 10b, a description thereof is omitted. Since a form of an end portion 20b of the terminal electrode 20B is also the same as or similar to a form of the end portion 20b of the terminal electrode 20A, a description thereof is omitted.

As described above, the element body 10 of the coil component 1 is composed of the magnetic powder-containing resin 11 including the magnetic powders 15 and 16, and the end portions 20a of the terminal electrodes 20A and 20B extending parallel to the mounting surface 10b protrude from the edges on the end surfaces 10c and 10d side. Therefore, the end surfaces 10c and 10d of the element body 10 are less likely to receive mechanical stress, for example, during the above-described wet etching process or barrel polishing process, and are particularly less likely to receive stress in a region near the mounting surface 10b where the terminal electrodes 20A and 20B protrude. Thereby, the magnetic powders 15 and 16 of the magnetic powder-containing resin 11 are less likely to be fallen off on the end surfaces 10c and 10d, a decrease in the magnetic properties of the element body 10 is suppressed, and an improvement in coil characteristics such as an inductance value is realized in the coil component 1.

In the coil component 1, the end portions of the insulating substrate 31 of the coil 30 protrude from the end surfaces 10c and 10d. Therefore, the end surfaces 10c and 10d of the element body 10 are also less likely to receive mechanical stress during the wet etching process or the barrel polishing process even in a peripheral region of the insulating substrate 31. Thereby, the magnetic powders 15 and 16 of the magnetic powder-containing resin 11 are further less likely to be fallen off on the end surfaces 10c and 10d, and the coil characteristics are further enhanced.

In the embodiment described above, the main surfaces 10a and 10b of the element body 10 are covered by the covering materials 12 and 14, and oxidation of the main surfaces 10a and 10b is suppressed by the covering materials 12 and 14.

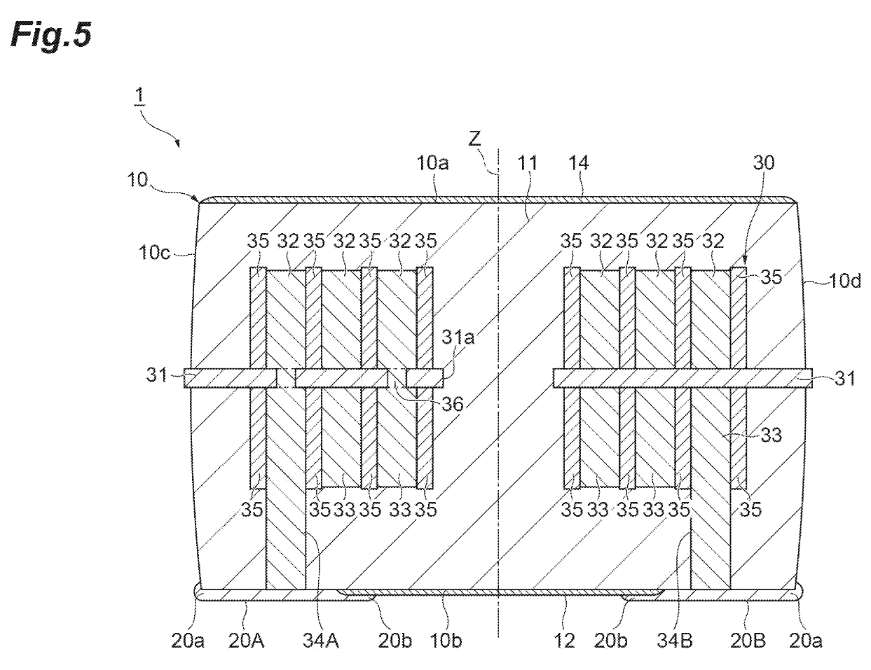

The magnetic powder-containing resin 11 on the end surfaces 10c and 10d of the element body 10 does not necessarily need to be entirely recessed, and may be an aspect in which it is partially recessed. Further, the magnetic powder-containing resin 11 on the end surfaces 10c and 10d of the element body 10 may be convex toward the outside. In the aspect illustrated in FIG. 5, the magnetic powder-containing resin 11 on the end surfaces 10c and 10d of the element body 10 is entirely convex toward the outside. Also in the coil component 1 illustrated in FIG. 5, the terminal electrodes 20A and 20B extend parallel to the mounting surface 10b and protrude from the edges on the end surfaces 10c and 10d side on the mounting surface 10b, respectively, whereby an improvement in coil characteristics such as an inductance value is realized.

In the coil component 1 illustrated in FIG. 5, the end portions 20a of the terminal electrodes 20A and 20B wrap around to the end surfaces 10c and 10d side, but the end portions 20a of the terminal electrodes 20A and 20B may not wrap around to the end surface 10c side at all, and the end surfaces 10c and 10d may be completely exposed from the terminal electrodes 20A and 20B. The magnetic powder-containing resin 11 on the end surfaces 10c and 10d of the element body 10 does not necessarily need to be entirely convex, and may be an aspect in which it is partially convex.

The present disclosure is not limited to the embodiments described above, and can be variously modified. For example, the magnetic powder of the magnetic powder-containing resin constituting the element body of the coil may be a mixed powder of three or more types of magnetic powders having different average particle diameters. The coil is not limited to the form described above, and may be, for example, a form that does not include a substrate. Further, the coil may be wound around a coil axis parallel to the mounting surface.

What is claimed is:

1. A coil component comprising:
an element body having a first surface and a pair of end surfaces facing each other in a direction parallel to the first surface and connected to the first surface, the element body is composed of a magnetic material including magnetic powder;
a coil disposed in the element body and having both end portions extracted to the first surface; and
a pair of terminal electrodes provided on the first surface and electrically connected to both of the end portions of the coil, respectively,
wherein the terminal electrode extends parallel to the first surface and protrudes from an edge on the end surface side on the first surface.

2. The coil component according to claim 1, wherein the magnetic material on the end surface is entirely recessed.

3. The coil component according to claim 1, wherein the coil has an insulating substrate extending parallel to the first surface and exposed from each of the pair of end surfaces, and a pair of planar coils provided on both surfaces of the insulating substrate,
the pair of planar coils have respective outer peripheral ends constituting both of the end portions of the coil, and have inner peripheral ends electrically connected to each other, and
the insulating substrate protrudes from the magnetic material on the end surface of the element body.

4. The coil component according to claim 3, wherein the terminal electrodes protrude from the insulating substrate on the end surface of the element body.

5. The coil component according to claim 4, wherein a surface of the terminal electrodes is composed of a conductive layer, and the conductive layer of the terminal electrodes protrudes from the insulating substrate on the end surface of the element body.

6. The coil component according to claim 1, wherein the element body has a rectangular parallelepiped outer shape and has a main surface parallel to the first surface, and
each of the first surface and the main surface of the element body is covered.
